(19) United States
(12) Patent Application Publication
(10) Pub. No.: US 2012/0198444 A1
(43) Pub. Date: Aug. 2, 2012

(54) PLAYING TELEVISION PROGRAM IN VIRTUAL ENVIRONMENT

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/234,013

(22) Filed: Sep. 15, 2011

(30) Foreign Application Priority Data
Jan. 28, 2011 (TW) 100103210

(51) Int. Cl. G06F 9/455

(52) U.S. Cl. 718/1

(57) ABSTRACT

In a virtual environment, a virtual machine (VM) host includes a host screen and a first host window displayed in the host screen. AVM guest is instantiated on the VM host. The VM guest includes a guest screen that is presented in the first host window. The VM launches a television player application and instructs the television player application to play a television program in the guest screen. The VM host registers a content server with a content receiver via a network. The content receiver receives one or more content items from the content server. The VM host creates a second host window displayed in the host screen and display the one or more content items in the second host window.

### CROSS-REFERENCE TO RELATED APPLICATIONS

Relevant subject matter is disclosed in co-pending U.S. Patent Applications entitled “PLAYING TELEVISION PROGRAM IN VIRTUAL ENVIRONMENT”, Attorney Docket Number US37737, U.S. application Ser. No. ______, Filed on ______, and “PLAYING TELEVISION PROGRAM IN VIRTUAL ENVIRONMENT”, Attorney Docket Number US37796, U.S. application Ser. No. ______, Filed on ______.

### BACKGROUND

1. Technical Field

The disclosure generally relates to a method and a system for playing a television program in a virtual environment.

2. Description of Related Art

A user may watch television programs via a computer, which has a TV tuner module such as a built-in TV tuner card or a USB TV tuner stick. The TV tuner module is able to receive and process television signals and output video/audio stream. It is desirable to display various types of information, such as E-mail, news, weather forecast, social network service (SNS) message and really simple syndication (RSS) feed, on the display while the user is watching television programs. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of a computer system in which virtual machines are configured.

FIG. 2 is a schematic diagram of one embodiment of a network, which the computer system can operate.

FIG. 3 illustrates a view of one embodiment of a graphic user interface for displaying host windows in a host screen of a VM host.

FIG. 4 illustrates a view of one embodiment of a graphic user interface for playing a television program in the computer system of FIG. 1.

FIG. 5 illustrates a view of one embodiment of a graphic user interface for displaying detailed content of a content item selected by a user.

FIG. 6 is an operational flow diagram representing an exemplary embodiment of a method of playing a television program in the computer system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

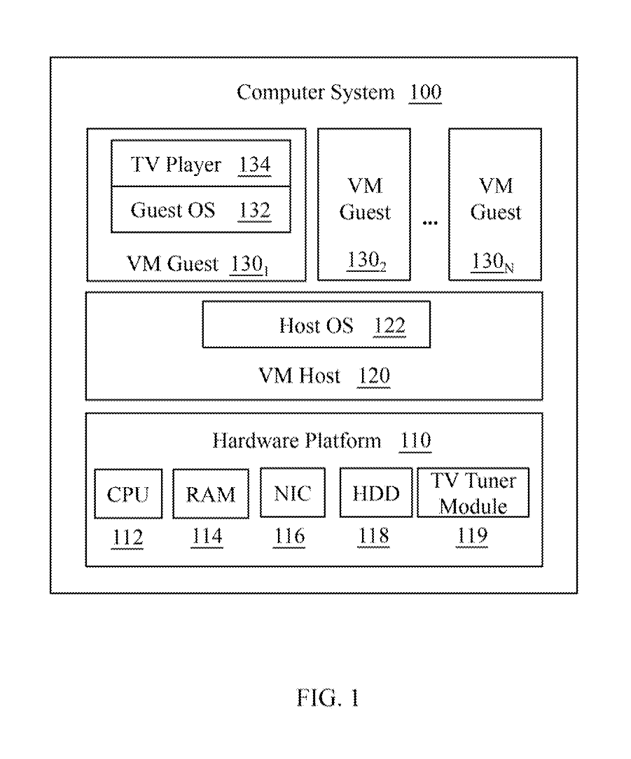

FIG. 1 depicts a block diagram of virtual machines that are configured on a computer system 100. The computer system 100 may be constructed on a desktop, a laptop or on a server grade hardware platform 110 such as an x86 architecture platform. Such a hardware platform may include a central processing unit (CPU) 112, a random access memory (RAM) 114, a network interface controller (NIC) 116 (also referred to as a network card), a hard disk drive (HDD) 118, a TV tuner module 119 and other I/O devices such as a mouse and a keyboard (not shown in FIG. 1).

The computer system 100 can operate one or more virtual machine (VM) guests 130₁, 130₂ . . . 130_{N}, collectively designated by a reference numeral 130, by installing a VM host 120 with a host operating system (OS) 122 for operating the VM guests 130. Each of the VM guests 130 may include a guest OS and one or more software applications. For example, the VM guest 130₁ includes a guest OS 132 and a TV player application 134 that is installed and executable in the VM guest 130₁.

The VM host 120 may control the hardware platform 110, present to the VM guests 130 virtualized hardware resources, and manage the VM guests 130. Multiple instances of the VM guests 130 may share the virtualized hardware resources and each of them may execute programs as if it was a physical machine.

The VM host 120 may provide a host window, in which a guest screen of one of the VM guests 130 can be presented. Each of the VM guests 130 may run multiple software applications in the corresponding host window. One software application of a VM guest may form one or more guest windows displayed in the guest screen of the VM guest to play as a user interface for itself.

The TV tuner module 119 may receive and process television signals and output video/audio stream. The television signals may be analog television signals or digital television signals, which depends on the television service provider. The TV tuner module 119 may be a TV tuner card with a PCI interface or a TV tuner stick with a USB interface. In some embodiments, the TV tuner module 119 may include a remote control receiver that may receive and identify remote commands from a remote control.

The TV player application 134, which is installed in the VM guest 130₁, may operate and control the TV tuner module 119 to expose all features of the TV tuner module 119. The TV player application 134 may play the video/audio stream generated by the TV tuner module 119.

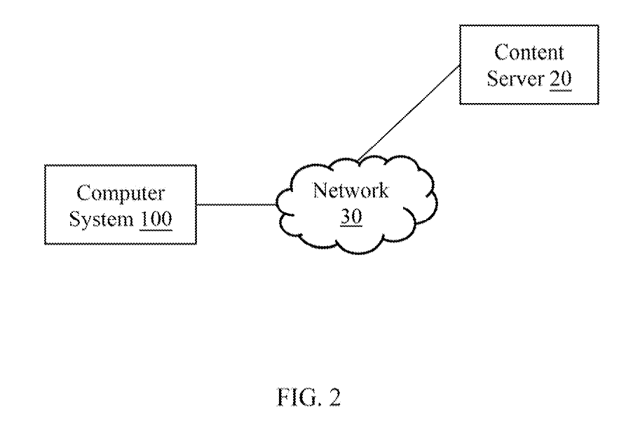

With reference to FIG. 2, the computer system 100 may operate in a network 30 using logical connection to one or more remote computers through the NIC 116. The network 30 may be a local area network (LAN) or a wide area network (WAN). The NIC 116 may be a network adapter card using a specific physical layer and a data link layer standard such as Ethernet or Wi-Fi. When used in a WAN networking environment, the computer system 100 typically includes a modem or other means for establishing communications over the WAN, such as the Internet.

The computer system 100 may be in communication with a content server 20 via the network 30. The content server 20 may be provided by a news website, a social network service (SNS) website, a really simple syndication (RSS) website, an E-mail service provider, or an instant message (IM) service provider. The content server 20 may provide the computer system 100 with a variety of content items, for example news, IM messages, SNS messages, RSS feeds, E-mail messages and weather forecasts.

The VM host 120 may include a content receiver adapted to establish a connection to the content server 20 and receive content items from the content server 20.

The computer system 100 may assign a unique Internet protocol (IP) address for each of the VM guests 130 manually or automatically. The computer system may create an Address Resolution Protocol (ARP) table that stores and maintains IP addresses of the VM guests 130. The ARP table may further store a VM ID or an MAC address to mark a unique IP address for each VM guest. The VM ID is an identification key to identify a unique VM guest. The VM host 120 assigns the MAC address when the corresponding VM guest is created. Each of the VM guests 130 has a unique MAC address, which can be recognized in a local area network (LAN) or a wide area network (WAN) such as the Internet. The IP address of a VM guest can be acquired from the ARP table according to either the VM ID or the MAC address of the VM guest.

The VM host 120 may establish a connection channel based on transmission control protocol (TCP) between the VM host 120 and each of the VM guests 130. For example, when a connection channel is established between the VM host 120 and the VM guest 130₁, the VM host 120 and the VM guest 130₁ can communicate with each other.

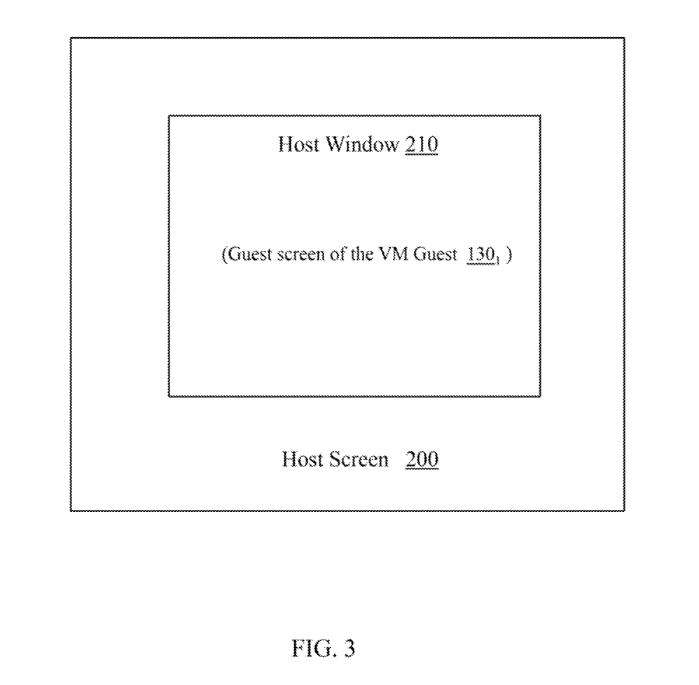

In FIG. 3, one embodiment of a graphic user interface for displaying a host window 210 in a host screen 200 of the VM host 120 is shown. A guest screen of the VM guest 130₁ is presented in the host window 210. The VM guest 130₁ may run arbitrary software applications and display the corresponding windows of the software applications in the guest screen of the VM guest 130₁.

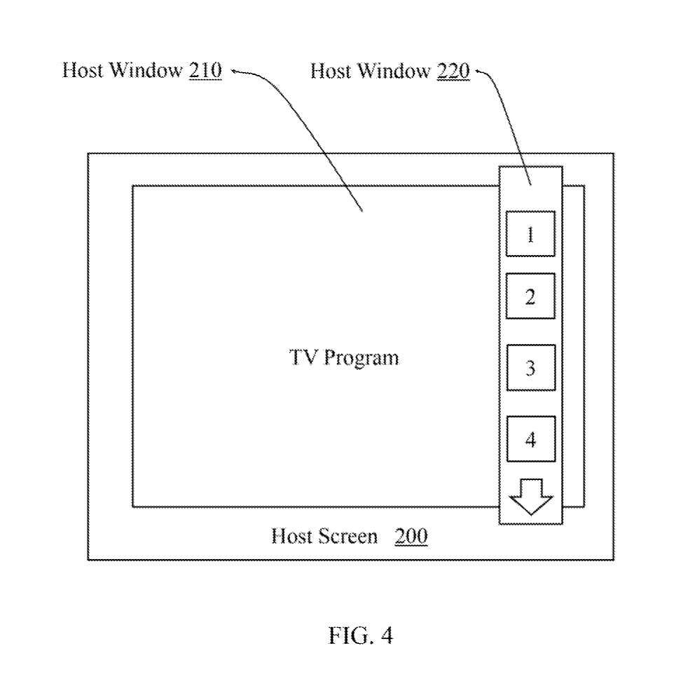

In FIG. 4, the VM guest 130₁ launches the TV player application 134 and instructs the TV player application 134 to play a television program in the guest screen of the VM guest 130₁ presented in the host window 210.

The VM host 120 may register the content server 20 with the content receiver via the network 30. The content receiver thus may receive one or more content items from the content server 20. The content server 20 may be associated with a universal resource locator, which locates and identifies the content server 20. The VM host 120 may identify and register the content server 20 with the content receiver on the basis of the URL of the content server 20.

When content receiver has received one or more content items from the content server 20, the VM host 120 can create a host window 220 displayed in the host screen 200 and display the one or more content items in the host window 220. The host window 220 may be presented near one of the sides of the host window 210 and partially overlap the host window 210. For example, the host window 220 may be laid on the right side of the host window 210. In order not to disturb the viewer, the VM host 120 may provide the host window 220 with a transparent background. In some embodiments, the host window 220 may be in a long and narrow shape.

In some embodiments, each of the content items may be associated with an expiration date. The content receiver may determine whether each of the content items has been expired. If one of the content items is expired, the content receiver may delete that expired content item.

The content receiver may poll the content server 20 for content items at periodic time intervals, such as every 30 seconds. The content receiver may record time stamp of each of polls of the content server 20. Once the content receiver receives a content item from the content server 20, the content receiver may compare time stamp of the received content item with a stored time stamp associated with the preceding poll of the content server 20. If the time stamp of the received content item is newer than the time stamp of the preceding poll of the server 20, the content receiver may determine that the received content item is a new content item from the content server 20 since the preceding poll of the content server 20. According to the determination, the VM host 120 may display the new content item in the host window 220.

The VM host 120 may hide the host window 220 when the remote control receiver of the TV tuner module 119 receives a hide command from a remote control. When a unhide command is received and identified by the remote control receiver, the VM host 120 may unhide the host window 220.

When too many content items are received from the content server 20 or each content contains too much data to display in the host window 220 at one time, the VM host 120 may display the profiles of the content items in the host window 220, for example titles, thumb images, or abstracts of the content items. In FIG. 4, the VM host 120 displays profiles of four content items in every page of the host window and may turn the pages by clicking a page turning button.

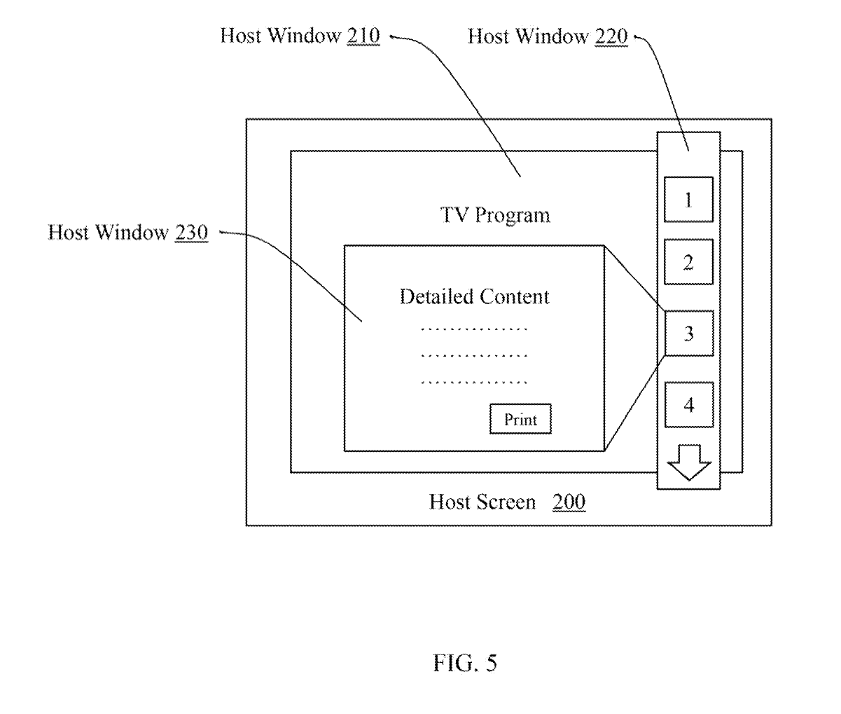

In FIG. 5, the content item 3 is selected according to a user selection. The VM host 120 may create a host window 230 and display the detailed content of the selected content item 3 in the host window 230. The host window 230 is laid on top of the host window 210 and has a smaller size than the size of the host window 210. In some embodiments, the VM host 120 may be coupled to a printer and may instruct the printer to print the detailed content of the selected content item 3 when the user clicks the print button in the host window 210.

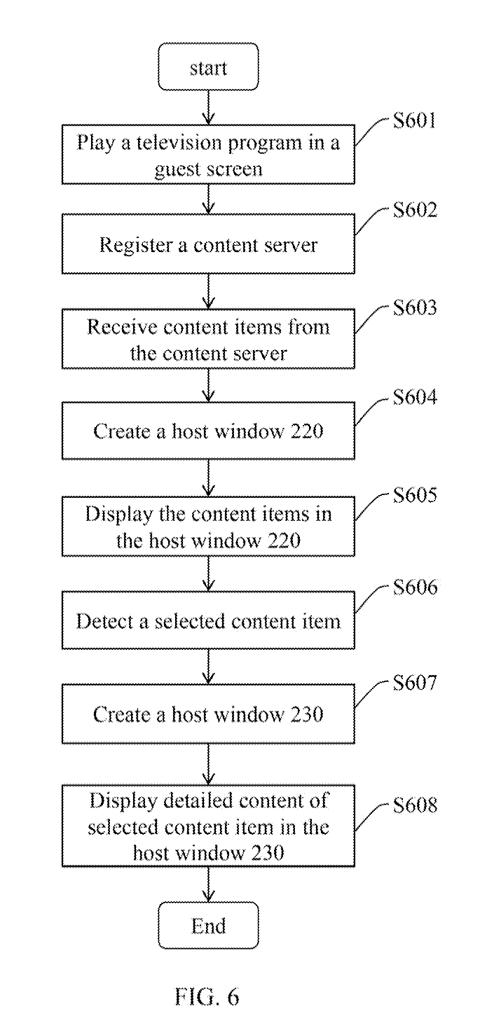

FIG. 6 is a flowchart illustrating one embodiment of a method of playing a television program in the computer system 100. The method may include the following steps.

In step S601, the VM guest 130₁ launches the TV player application 134 and instructs the TV player application 134 to play a television program in the guest screen of the VM guest 130₁ which is presented in the host window 210 .

In step S602, The VM host 120 registers the content server 20 with the content receiver via the network 30.

In step S603, the content receiver receives one or more content items from the content server 20.

In step S604, the VM host 120 creates the host window 220 displayed in the host screen 200.

In step S605, the VM host 120 displays the one or more content items in the host window 220.

In step S606, the VM host 120 detects that a content item is selected by a user.

In step S607, the VM host 120 creates the host window 230 displayed in the host screen 200.

In step S608, the VM host 120 displayed the detailed content of the selected content item in the host window 230.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A computer-implemented method for playing a television program, the method comprising:
providing a computer system comprising a virtual machine (VM) host and a VM guest instantiated on the VM host, the VM host having a host screen, a first host window displayed in the host screen and a content receiver, the VM guest having a guest screen that is presented in the first host window and a television player application;
launching the television player application;
instructing the television player application to play the television program in the guest screen by the VM guest;
registering a content server with the content receiver via a network;
receiving one or more content items from the content server by the content receiver;
creating a second host window displayed in the host screen by the VM host; and
displaying the one or more content items in the second host window by the VM host.

2. The method of claim 1, further comprising:
polling the content server for content items by the content receiver;
determining whether the content receiver has received a new content item from the content server since a preceding poll of the content server; and
when the content receiver receives the new content item, displaying the new content item in the second host window by the VM host.

3. The method of claim 2, wherein the determining whether the content receiver receives the new content item comprises comparing time stamp of the new content item with a stored time stamp associated with the preceding poll of the content server.

4. The method of claim 2, wherein the polling is carried out at periodic time intervals.

5. The method of claim 1, further comprising:
selecting a target content item from the one or more content items according to a user selection from the second host window;
creating a third host window displayed in the host screen by the VM host; and
displaying detailed content of the target content item in the third host window by the VM host.

6. The method of claim 1, further comprising hiding the second host window when a remote control receiver of the computer system receives a hiding command from a remote control.

7. The method of claim 1, wherein the second host window partially overlaps the first window.

8. The method of claim 1, wherein each of the one or more content items is associated with an expiration date.

9. The method of claim 8, further comprising deleting one of the one or more content items in a determination that the one of the one or more content items has been expired.

10. The method of claim 1, wherein the registering is carried out by identification of the content server on the basis of a universal resource locator (URL).

11. A computer system comprising:
a virtual machine (VM) host comprising a host screen, a first host window displayed in the host screen and a content receiver;
a VM guest instantiated on the VM host, the VM guest comprising a guest screen that is presented in the first host window and a television player application;
wherein the VM guest is adapted to launch the television player application and instruct the television player application to play a television program in the guest screen, the VM host is adapted to register a content server with the content receiver via a network, and the content receiver is adapted to receive one or more content items from the content server; and
wherein the VM host is further adapted to create a second host window displayed in the host screen and display the one or more content items in the second host window.

12. The computer system of claim 11, wherein the content receiver is further adapted to poll the content server for content items and determine whether the content receiver receives a new content item from the content server since a preceding poll of the content server, and the VM host is further adapted to display the new content item in the second host window when the content receiver receives the new content item.

13. The computer system of claim 12, wherein the content receiver is further adapted to compare time stamp of the new content item with a stored time stamp associated with the preceding poll of the content server.

14. The computer system of claim 12, wherein the content receiver is adapted to poll the content server for content items at periodic time intervals.

15. The computer system of claim 11, wherein the VM host is further adapted to select a target content item from the one or more content items according to a user selection from the second host window, create a third host window displayed in the host screen and display detailed content of the target content item in the third host window.

16. The computer system of claim 11, further comprising a remote control receiver adapted to receive a hiding command from a remote control, and wherein the VM host is further to hide the second host window when the remote control receiver receives the hiding command

17. The computer system of claim 11, wherein the second host window partially overlaps the first window.

18. The computer system of claim 11, wherein each of the one or more content items is associated with an expiration date.

19. The computer system of claim 18, wherein the content receiver is further adapted to delete one of the one or more content items in a determination that the one of the one or more content items has been expired.

20. The computer system of claim 11, wherein the VM host is adapted to register the content server with the content receiver by identification of the content server on the basis of a universal resource locator (URL).
